(19) United States
(12) Patent Application Publication
(10) Pub. No.: US 2024/0377531 A1
(43) Pub. Date: Nov. 14, 2024

(54) SYSTEMS, APPARATUSES, AND METHODS FOR FAN BEAM TRANSDUCERS

(71) Applicant: CERULEAN SONAR LLC, WAYZATA, MN (US)

(72) Inventors: Lawrence J. Lukis, Wayzata, MN (US); Donald G. Krantz, Wayzata, MN (US); Nicholas James Nothom, Minneapolis, MN (US)

(21) Appl. No.: 18/652,405

(22) Filed: May 1, 2024

Related U.S. Application Data
(60) Provisional application No. 63/466,016, filed on May 12, 2023.

(51) Int. Cl. G01S 15/89; G01S 7/62; G01S 15/60

(52) U.S. Cl. CPC G01S 15/8902; G01S 15/60; G01S 7/6218

(57) ABSTRACT

Systems, apparatuses, and methods for fan beams are provided. In various embodiments, the fan beams may be for sonar systems, radar systems, and lidar systems. An exemplary sonar system may comprise a transducer configured to generate a fan beam and a display to render one or more images. The sonar system may generate a plurality of fan beams with the transducer; receive, with the transducer, a plurality of reflections based on the fan beams; determine a velocity of the sonar system based on the reflections; generate a plurality of first images based on the velocity and the reflections; and render the plurality of first images on the display. In various embodiments, the transducer may be mounted on a vehicle and the velocity may also be used to control the positioning of the vehicle.

### CROSS-REFERENCE TO RELATED APPLICATION

This application claims the priority benefit of U.S. Provisional Patent Application No. 63/466,016 filed on May 12, 2023, and entitled “Systems, Apparatuses, and Methods for Fan Beam Transducers,” which is hereby incorporated by reference in its entirety and to the maximum extent allowable by law.

### TECHNOLOGICAL FIELD

Example embodiments of the present disclosure relate generally to systems, apparatuses, and methods for fan beam transducers, particularly for fan beam transducers used with sonar, radar, and laser to determine or estimate motion between the fan beam transducer and an object.

### BACKGROUND

Transducers have been used to generate sonar beams, radar beams, and laser beams. The shape of some beams created by some of these transducers is longer in a first direction than in a second direction and may be referred to as a fan beam. Various applications utilize fan beam transducers.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to systems, apparatuses, and methods for fan beam transducers.

In accordance with some embodiments of the present disclosure, an example sonar system is provided. The sonar system comprising: a transducer configured to generate a fan beam; a display configured to render one or more images; a processor and at least one non-transitory memory comprising computer program code, wherein the at least one non-transitory memory and the computer program code configured to, with the at least one processor, cause the sonar system to: generate a plurality of fan beams with the transducer; receive, with the transducer, a plurality of reflections based on the fan beams; determine a velocity of the sonar system based on the reflections; generate a plurality of first images based on the velocity and the reflections; and render the plurality of first images on the display.

In some embodiments, to generate the plurality of first images based on the velocity and the reflections the at least one non-transitory memory and the computer program code are further configured to, with the at least one processor, cause the sonar system to: generate a plurality of initial images based on the reflections; and generate the plurality of first images based on the plurality of initial images updated to compensate for the velocity of the sonar system.

In some embodiments, to determine the velocity of the sonar system based on the reflections the at least one non-transitory memory and the computer program code are further configured to, with the at least one processor, cause the sonar system to: generate a plurality of return signals based on the reflections, wherein the plurality of return signals have a frequency of a broadcast frequency; generate a plurality of down converted signals by down converting the plurality of return signals from the broadcast frequency to a baseband frequency; determine a Doppler shift in the plurality of down converted signals based on the baseband frequency; and determine the velocity of the sonar system based on a plurality of phase measurements of the plurality of down converted signals and the Doppler shift.

In some embodiments, the display is located remotely from the transducer.

In some embodiments, the transducer is mounted on an underwater vehicle.

In some embodiments, the sonar system of claim 1 further comprising a conical transducer; the at least one non-transitory memory and the computer program code are further configured to, with the at least one processor, cause the sonar system to determine a depth of a standoff range with the conical transducer; and to determine the velocity of the sonar system is further based on the depth.

In some embodiments, to render the plurality of first images on the display is to render the plurality of first images in real-time.

In accordance with some embodiments of the present disclosure, an example method is provided. The method comprises: providing a sonar system comprising: a transducer configured to generate a fan beam; a display configured to render one or more images; generating, with the transducer, a plurality of fan beams with the transducer; receiving, with the transducer, a plurality of reflections based on the fan beams; determining a velocity of the sonar system based on the reflections; generating a plurality of first images based on the velocity and the reflections; and rendering the plurality of first images on the display.

In some embodiments, generating the plurality of first images based on the velocity and the reflections comprises: generating a plurality of initial images based on the reflections; and generating the plurality of first images based on the plurality of initial images updated to compensate for the velocity of the sonar system.

In some embodiments, determining the velocity of the sonar system based on the reflections comprises: generating a plurality of return signals based on the reflections, wherein the plurality of return signals have a frequency of a broadcast frequency; generating a plurality of down converted signals by down converting the plurality of return signals from the broadcast frequency to a baseband frequency; determining a Doppler shift in the plurality of down converted signals based on the baseband frequency; determining the velocity of the sonar system based on a plurality of phase measurements of the plurality of down converted signals and the Doppler shift.

In some embodiments, the display is located remotely from the transducer.

In some embodiments, the transducer is mounted on an underwater vehicle.

In some embodiments, the sonar system further comprises a conical transducer; wherein the method further comprises determine a depth of a standoff range with the conical transducer; and wherein determining the velocity of the sonar system is further based on the depth.

In some embodiments, rendering the plurality of first images on the display comprises rendering the plurality of first images in real-time.

In accordance with some embodiments of the present disclosure, an second example system is provided. The second system comprising: a sonar system mounted to a vehicle, wherein the sonar system includes a transducer configured to generate a fan beam; a display configured to render one or more images; wherein the vehicle comprises a propulsion system configured to move the vehicle in a first environment; a processor and at least one non-transitory memory comprising computer program code, wherein the at least one non-transitory memory and the computer program code configured to, with the at least one processor, cause the system to: generate a plurality of fan beams with the transducer; receive, with the transducer, a plurality of reflections based on the fan beams; determine a velocity of the sonar system based on the reflections; generate a plurality of first images based on the velocity and the reflections; render the plurality of first images on the display; and generate one or more position signals based on the velocity to cause the vehicle to move in one or more directions to hold the vehicle in a position and counteract one or more forces of the environment moving the vehicle.

In some embodiments, to generate the plurality of first images based on the velocity and the reflections the at least one non-transitory memory and the computer program code are further configured to, with the at least one processor, cause the sonar system to: generate a plurality of initial images based on the reflections; and generate the plurality of first images based on the plurality of initial images updated to compensate for the velocity of the sonar system.

In some embodiments, to determine the velocity of the sonar system based on the reflections the at least one non-transitory memory and the computer program code are further configured to, with the at least one processor, cause the sonar system to: generate a plurality of return signals based on the reflections, wherein the plurality of return signals have a frequency of a broadcast frequency; generate a plurality of down converted signals by down converting the plurality of return signals from the broadcast frequency to a baseband frequency; determine a Doppler shift in the plurality of down converted signals based on the baseband frequency; determine the velocity of the sonar system based on a plurality of phase measurements of the plurality of down converted signals and the Doppler shift.

In some embodiments, the display is located remotely from the transducer.

In some embodiments, the sonar system further comprises a conical transducer; wherein the at least one non-transitory memory and the computer program code are further configured to, with the at least one processor, cause the sonar system to determine a depth of a standoff range with the conical transducer; and wherein to determine the velocity of the sonar system is further based on the depth.

In some embodiments, to render the plurality of first images on the display is to render the plurality of first images in real-time.

In accordance with some embodiments of the present disclosure, a third example system is provided. The third system comprising: a sonar system mounted to a vehicle, wherein the sonar system includes a transducer configured to generate a fan beam; wherein the vehicle comprises a propulsion system configured to move the vehicle in a first environment; a processor and at least one non-transitory memory comprising computer program code, wherein the at least one non-transitory memory and the computer program code configured to, with the at least one processor, cause the system to: generate a plurality of fan beams with the transducer; receive, with the transducer, a plurality of reflections based on the fan beams; determine a velocity of the sonar system based on the reflections; and generate one or more position signals based on the velocity to cause the vehicle to move in one or more directions to hold the vehicle in a position and counteract one or more forces of the environment moving the vehicle.

In accordance with some embodiments of the present disclosure, a fourth example system is provided. The fourth system comprising: a radar system mounted to a vehicle, wherein the radar system includes a transducer configured to generate a fan beam; wherein the vehicle comprises a propulsion system configured to move the vehicle in a first environment; a processor and at least one non-transitory memory comprising computer program code, wherein the at least one non-transitory memory and the computer program code configured to, with the at least one processor, cause the system to: generate a plurality of fan beams with the transducer; receive, with the transducer, a plurality of reflections based on the fan beams; determine a velocity of the radar system based on the reflections; and generate one or more position signals based on the velocity to cause the vehicle to move in one or more directions to hold the vehicle in a position and counteract one or more forces of the environment moving the vehicle.

In accordance with some embodiments of the present disclosure, a fifth example system is provided. The fifth system comprising: a lidar system mounted to a vehicle, wherein the lidar system includes a transducer configured to generate a fan beam; wherein the vehicle comprises a propulsion system configured to move the vehicle in a first environment; a processor and at least one non-transitory memory comprising computer program code, wherein the at least one non-transitory memory and the computer program code configured to, with the at least one processor, cause the system to: generate a plurality of fan beams with the transducer; receive, with the transducer, a plurality of reflections based on the fan beams; determine a velocity of the lidar system based on the reflections; and generate one or more position signals based on the velocity to cause the vehicle to move in one or more directions to hold the vehicle in a position and counteract one or more forces of the environment moving the vehicle.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure, reference will now be made to the accompanying drawings, which are not necessarily drawn to scale, and wherein:

FIG. 1 illustrates an example environment with a vehicle utilizing a fan-beam in accordance with one or more embodiments of the present disclosure;

FIGS. 2A-2D illustrate an example fan beam from different perspectives in accordance with one or more embodiments of the present disclosure;

FIGS. 3A and 3B illustrate example beam pattern plots of a fan beam in accordance with one or more embodiments of the present disclosure;

FIGS. 4A-4C illustrate an example fan beam in an underwater environment in accordance with one or more embodiments of the present disclosure;

FIGS. 5A-5C illustrate exemplary images of an underwater vehicle with a transducer using a fan beam sonar in accordance with one or more embodiments of the present disclosure;

FIGS. 6A-6F illustrate graphs of return signal processing operations in accordance with one or more embodiments of the present disclosure;

FIG. 7 illustrates an exemplary flowchart of operations for generating an image based on one or more fan sonar beams in accordance with one or more embodiments of the present disclosure;

FIG. 8 illustrates an exemplary flowchart of operations for generating image data based on velocity and reflections in accordance with one or more embodiments of the present disclosure;

FIG. 9 illustrates an exemplary flowchart of operations for positioning a vehicle in accordance with one or more embodiments of the present disclosure;

FIG. 10 illustrates an exemplary flowchart of operations for interleaving imaging pings and Doppler pings in accordance with one or more embodiments of the present disclosure; and

FIG. 11 illustrates an example block hardware diagram of a device in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to improved systems, apparatuses, and method for fan beam transducers.

Example embodiments for fan beam transducers include, but are not limited to, sonar applications, radar applications, and laser interferometry applications. Such applications may include systems, vehicles, drones, and the like that may utilize the fan beam transducers. In some embodiments the fan beam transducer may be referred to as a sensor, which may be located in a sensor head. A sensor head may or may not include additional sensors used by one or more embodiments.

In various embodiments, the fan beam transducers may be included in a sonar system. The sonar system may include imaging sonar, such as used with a vehicle (e.g., a remote operated vehicles (ROVs), autonomous underwater vehicles, (AUV), surface vessels, and the like). The fan beam transducer may be mounted to the vehicle. The mounting may be fixed mounted or a rotational mount. The fan beam transducer may emit a fan beams that generates reflections. The reflections from the fan beams transmitted from the fan beam transducer may be used to generate and render a plurality of images on a display. As the ROV or surface vessel moves, the images of the scanned area of the sea floor give excellent situational awareness, including in the murkiest conditions.

Conventional systems using fan beam transducers include side-scan systems that may be difficult to understand or may have difficult in rendering images. For example, conventional side-scan systems may display a sequence of pings in a linear array and require post-processing with high end software tools to achieve correct image rendering. Further, while conventional side-scan systems may display images, these images may not be updated to reflect the motion of the transducer and, thus, the images displayed may be difficult to understand.

The present disclosure, in contrast to conventional side-scan systems, may generate geometrically correct images that may be rendered live in real time and/or recorded. For example, by facing the fan beam transducer forward, an operator may “paint” the seabed ahead of it and drive forward toward any items of interest (e.g., pipelines, wrecks, reefs, vegetation beds).

Fan beams may also be used to determine a velocity in a plane parallel to a target plane. The fan beam may further be used to determine a velocity normal to the target plane, or to determine both parallel and normal velocities simultaneously. Thus the fan beams from a fan beam transducer may be used to determine the relative motion between a sensor and a surface called a “target plane.” The relative motion in a principal axis of the fan beam may be determined while a system, apparatus, or method may, or may not, otherwise be insensitive to motion perpendicular to the principal axis of the fan beam.

In various embodiments of the present disclosure, the fan beams may be used for determining or estimating a velocity of a vehicle relative to, for example, the seabed. For example, the velocity measurements may be used when a vehicle is between 0.5 and 30 meters above a seabed. The velocity may be used as an odometry component of a dead-reckoning system. As such, updates at an update frequency (e.g., 10 Hz or faster) may reduce errors due to vehicle dynamics. This update frequency may be associated with a maximum range. In various embodiments of a sonar system with an update frequency of 10 Hz, a maximum range of a measurement may be 74.2 meters (assuming a nominal speed of sound in water of 1484 meters per second). In various embodiments, a maximum distance may be shorter or longer, such as required in various embodiments to address implementation overhead, and/or to allow for higher speeds of sound in water due to, for example, salinity and/or temperature differences.

Various embodiments may include fan beam transducers with different frequencies, ranges, and/or repeat rates. In various embodiments, a fan beam transducer operating at a carrier frequency, which may also be referred to as a broadcast frequency. A carrier frequency may be, for example, at 676,000 Hz. It will be appreciated other embodiments may use other carrier frequencies (e.g., 450,000 Hz).

Various embodiments may include one or more fan beam transducers being used along with one or more other sensors. Such sensors may be, for example, a conical beam transducer or depth finder. Various embodiments may include the velocity determination being piggybacked on one or more measurements or determination from these other sensors. Additionally or alternatively, fan beam systems may further provide improved reflections off many targets while a conical beam must find a reflective target within the narrow cone of the conical beam.

Various embodiments may also include additional sensors used in conjunction with a fan beam transducer, such as an inertial measurement unit (IMU) to measure a roll and/or a pitch of the sensor head including the IMU. The IMU may also provide a heading. In various embodiments, such information may be used alongside a Doppler capability described herein may extend this to translational capability to determine and/or estimate one or more changes in position of a sensor and/or a vehicle to which the fan beam transducer may be mounted.

Various embodiments may include a second fan beam transducer. The first fan beam transducer may be oriented in a first direction and the second fan beam transducer may be oriented in a different, second direction. Each fan beam transducer may be used to determine a velocity in its respective direction, which may allow for tracking vehicle velocity each of the directions.

Various embodiments may include communicating one or more signals based on the velocity to other components, circuitry, and/or modules in a system. For example, such signals may be transmitted to control and/or propulsion systems of a vehicle (e.g., ROV, AUV, drone, etc.), such as to enable a position hold. For example in an embodiment of a sonar system, the velocity may take into consideration and compensate for currents and/or motions in water for the sonar system. The holding of a position may be in response to one or more forces or other aspects of an environment the ROV, AUV, or the like is located in. For example, a sonar system may be mounted on a vehicle be in the ocean where a current, gravity, etc. may act on the sonar system to move it. As another example, a radar system may be mounted on a vehicle be in the air where a breeze, wind, gravity, etc. may act on the radar system to move it. As another example, a laser system may be mounted on a vehicle be in a road where an incline or decline of the road, gravity, etc. may act on the laser system to move it. As will be appreciated, each of these sonar systems, radar systems, and/or laser systems may generate one or more signals that provide the velocity to vehicle to cause the vehicle to increase or decrease movement to remain in position.

While the present disclosure may generally be described in relation to sonar, it will be appreciated the disclosure is equally applicable to radar and laser applications. Various embodiments may include a drone using radar, particularly when a drone may be in an area where GPS coverage is limited or does not work well (e.g., indoors, mines, caverns, tall buildings, etc.). A radar-based fan beam can be used to provide velocity. The velocity may be integrated to provide position or change in position (e.g., a delta-position). Also, multiple fan beams from fan beam transducers at different angles can provide velocity in two or three dimensions which can also be integrated to give 2-D or 3-D position or position-delta for dead-reckoning navigation and/or for autonomous position hold. Various embodiments may be used similarly for laser based applications. For example similar fan beams may be used for laser based speed detectors and/or target tracking.

Having described some details, exemplary systems, apparatuses, and method of the present disclosure will now be further described.

### Exemplary Systems, Apparatuses, and Methods

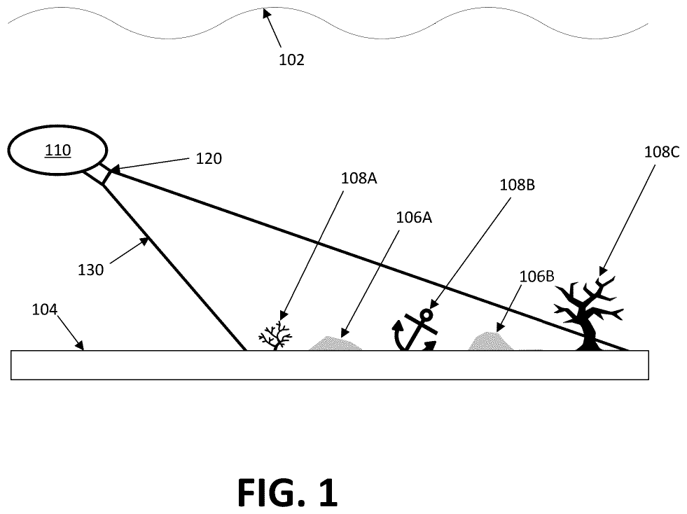

FIG. 1 illustrates an example environment with a vehicle utilizing a fan-beam in accordance with one or more embodiments of the present disclosure. The environment may be an underwater environment 100 that is below a water surface 102. Below the water surface 102 may include a floor 104 (e.g., sea floor, lakebed, ground, or the like). The floor 104 may include a plurality of floor surfaces 106 as well as objects 108. In various embodiments, the floor surfaces 106 may include contours of the floor 104, such as a first floor contour 106A and floor contour 106B. Floor contours 106 may include be rises, ridges, valleys, holes, and the like. Additionally or alternatively, an environment 100 may include one or more objects 108, which may be on or embedded in the floor 104. For example, an underwater environment 100 may include objects coral 108A, anchors 108B, wrecks, vehicles, trees 108C, and/or the like that have been grown, placed, or left in the underwater environment 100.

A vehicle, such an underwater vehicle 110 may explore an underwater environment 100. The underwater vehicle 110 may use, among other things, a transducer 120 that generates a fan beam 130. In various embodiments, the transducer 120 is incorporated into the underwater vehicle 110. Alternatively or additional, the transducer 120 may be externally attached to the underwater vehicle 110. It will be appreciated that while an underwater vehicle is illustrated, the vehicle may have only a portion underwater, such as a boat or the like with a transducer 120 mounted or placed below the water surface 102.

A transducer 120 may be included in a transducer housing that protects the transducer 120. In various embodiments, the transducer 120 may be in a sensor head that may include one or more additionally sensors in addition to the transducer 120. The transducer 120 may generate a fan beam 130 using, for example, SOund and NAvigation Ranging (SONAR). The fan beam 130 may be generated and projected towards one or more targets, such as the floor 104, floor surfaces 106, and/or objects 108. In various embodiments, the floor 104, floor surface 106, and objects 108 may generate returns based on the fan beam, which is described further herein. It will additionally be appreciated that the environment 100 may include other objects 108, such as fish or other animals, that may generate returns in response to the fan beam.

While FIG. 1 illustrates an underwater environment 100 and an underwater vehicle 110 with a transducer 120 configured for sonar, it will be appreciated that a transducer 120 generating a fan beam 130 may be used in other environments with other vehicles. For example, various embodiments may be of a drone having a radar transducer that may generate a fan radar beam. As additionally examples, various embodiments may be of a vehicle having a laser transducer that may generate a fan laser beam.

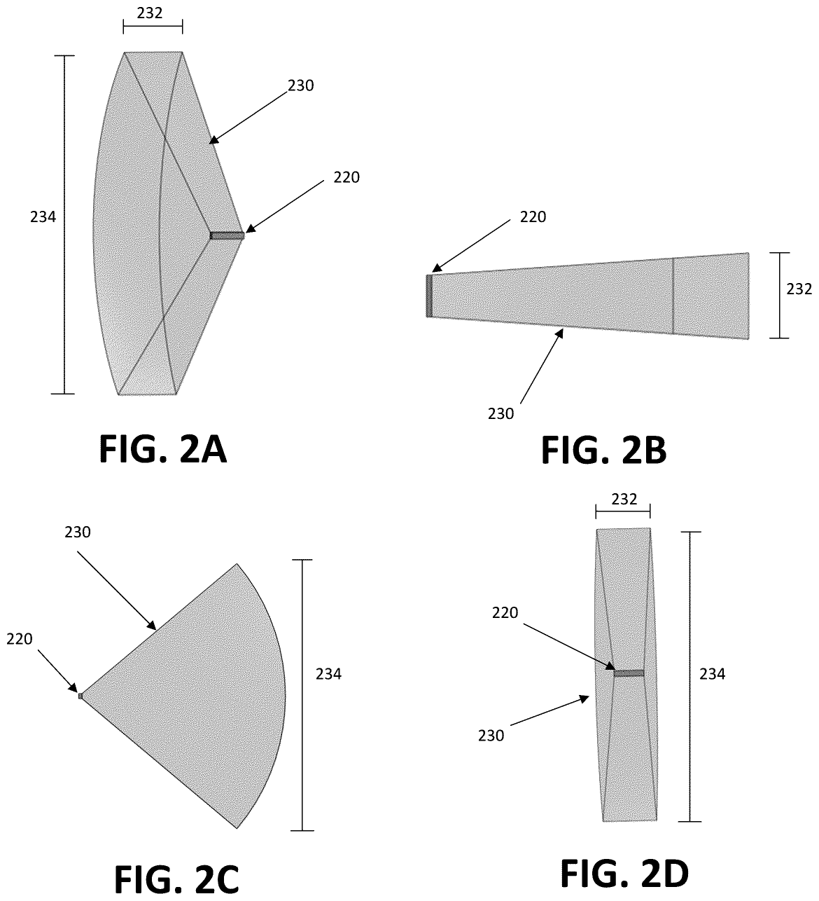

FIGS. 2A-2D illustrate an example fan beam from different perspectives in accordance with one or more embodiments of the present disclosure. A fan beam 230 is wide in a first direction and narrow in a second direction. The second direction being orthogonal to the first direction. In other words, the fan beam has a cross section that is wide in one dimension and narrow in another, second dimension.

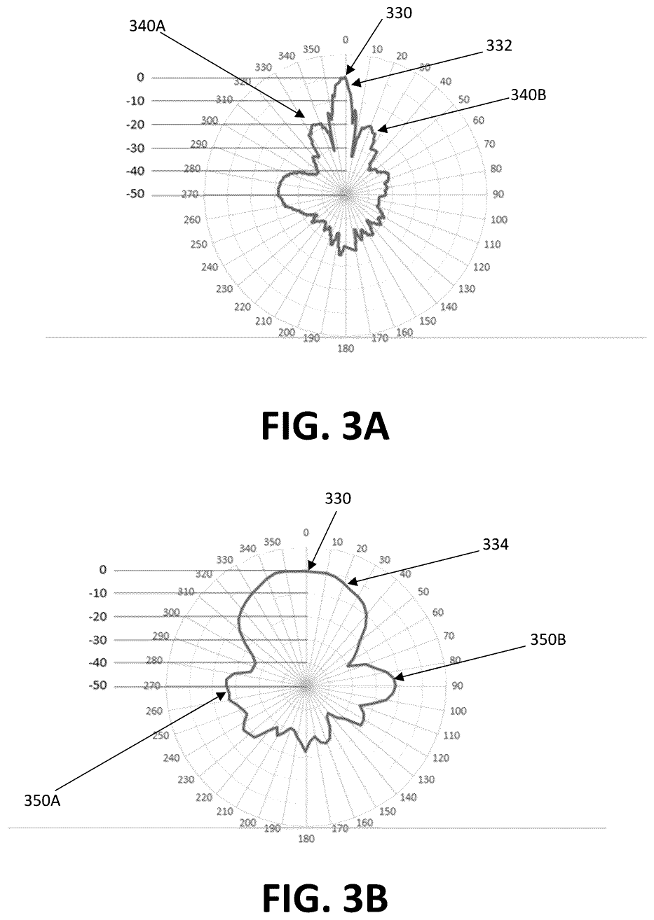

It will be appreciated that these illustrations of fan beams are, in practice, not having such clearly well-defined edges. The illustrations of FIGS. 2A-2D, and the references to a fan beam 230, refer to a main lobe of an emission pattern. Examples are illustrated further herein, including with respect to FIGS. 3A-3B. The illustrations of FIGS. 2A-2D illustrate the pattern of an idealized fan beam generated from a transducer 220 in a sonar application.

The fan beam 230 is generated by a fan beam transducer 220. The fan beam transducer 220 may be a sonar transducer, a radar transducer, or a laser transducer for generating, respectively, a fan beam 230 for a sonar application, a radar application, or a laser application. In various embodiments, the receive and transmit patterns of fan beam transducers, radio antennas, and laser optics are identical. The fan beam transducer 220 is longer in a first direction and narrow in a second direction. In various embodiments, the fan beam transducer 220 may be made of one or more elements that vibrate in response to receiving an electrical signal. Additionally, various embodiments may use different broadcast frequencies. The broadcast frequency is related to transducer size. In general, the higher the frequency the smaller the required transducer to achieve a specific fan beam shape. Higher frequencies also propagate less well than lower frequencies.

FIG. 2A illustrates an isometric view of a fan beam. The fan beam 230 has a first dimension 232 that is narrow and a second dimension 234 that is wide. The fan beam 230 is generate and emitted by the transducer 220. The fan beam 230 of FIG. 2A is projecting away from the transducer 220 (e.g., into the plane of the figure).

FIG. 2B illustrates a top-down view a fan beam. The fan beam 230 of FIG. 2B, particularly a main axis of the fan beam 230, is projecting away from the transducer 220 (e.g., to the right of the illustration). The fan beam 230 has a first dimension 232 that is narrow. From the view of FIG. 2B the wide dimension is not readily visible.

FIG. 2C illustrates a side view a fan beam. The fan beam 230 of FIG. 2C, particularly a main axis of the fan beam 230, is projecting away from the transducer 220 (e.g., to the right of the illustration). The fan beam 230 has a second dimension 234 that is wide. From the view of FIG. 2C the narrow dimension is not readily visible.

FIG. 2D illustrates a rear view a fan beam. The fan beam 230 of FIG. 2D, particularly a main axis of the fan beam 230, is projecting away from the transducer 220 (e.g., into the illustration or page). As illustrated in FIG. 2D, and in FIGS. 2A-2C too, the fan beam 230 expands outwardly from the transducer 220. The fan beam 230 has a first dimension 232 that is narrow and a second dimension 234 that is wide.

FIGS. 3A and 3B illustrate example beam pattern plots of a fan beam in accordance with one or more embodiments of the present disclosure.

As described herein, a transducer (e.g., 120) generates a beam, such as with one or more transducer elements that may vibrate in response to an electrical signal. The shape of the transducer (e.g., 120) and/or the composition of a transducer housing may shape the radiation generated by the transducer (e.g., 120). A beam may be generated in all directions, at least to some extent. Generally there will be a main axis of the beam that is strongest. A beam pattern may be defined by the points at 3 dB down from the maximum of where the beam is the strongest, which may indicate a shape of the beam. An example is a fan beam that is narrow in a first dimension and wide in a second dimension that is orthogonal to the first dimension. FIGS. 3A-3B illustrate exemplary beam pattern plots that illustrate how an exemplary transducer may emit a beam in a first dimension in FIG. 3A and in a second dimension in FIG. 3B.

The beam patterns of FIGS. 3A-3B are illustrated on a polar plot. The 0 degree vertical axis of these polar plots is associated with a main axis of a transducer 120 that emits a beam. The polar plot illustrates a cross-section of a beam pattern.

FIG. 3A illustrates a beam pattern of a fan beam in a first dimension in accordance with one or more embodiments of the present disclosure. The first dimension illustrated in FIG. 3A is the narrow dimension of a fan beam. The shape of a main lobe 330 of the fan beam in the first dimension 332 is measured at the −3 dB down from a peak. The width of the beam pattern of the main lobe 330 of the fan beam in this first dimension 332 is approximately 3 degrees.

The beam pattern in the first dimension also includes, among other things, first side lobes 340A and 340B in the first dimension. The side lobe 340A is at 335 degrees and the side lobe 340B is at 20 degrees. As illustrated, these side lobes peak at between approximately −15 dB and −20 dB from the maximum.

FIG. 3B illustrates a beam pattern of a fan beam in a second dimension in accordance with one or more embodiments of the present disclosure.

The second dimension is the wide dimension of a fan beam. The shape of a main lobe 330 of the fan beam in the second dimension 334 is measured at the −3 dB down from a peak. The width of the beam pattern of the main lobe 330 of the fan beam in this second dimension 334 is approximately 40 degrees.

The beam pattern in the second dimension also includes a first side lobes 350A and 350B. The side lobe 350A is at 270 degrees and the side lobe 350B is at 90 degrees. These side lobes peak at approximately −15 dB from the maximum.

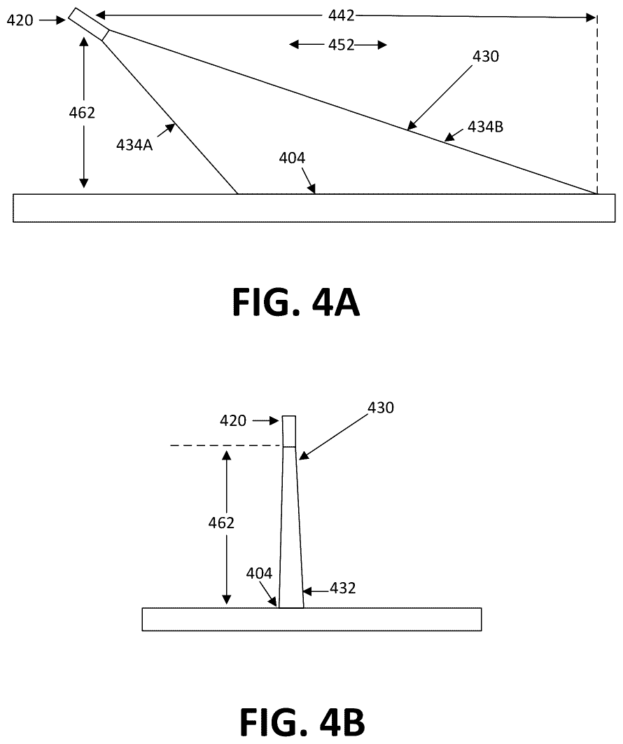

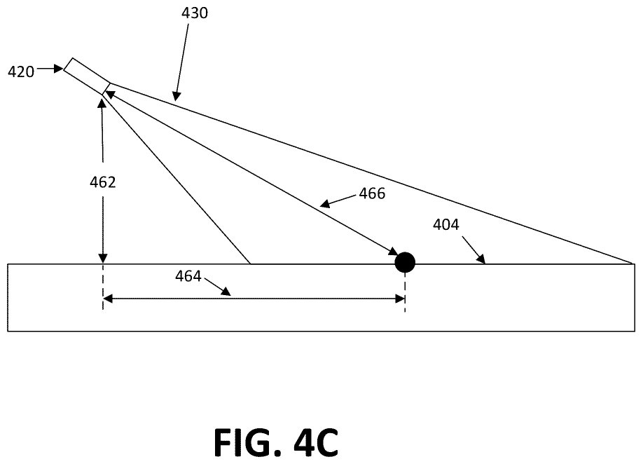

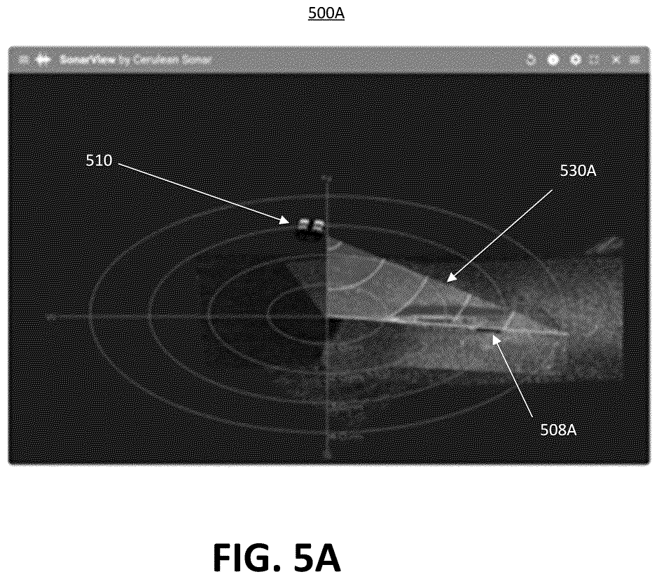

FIGS. 4A-4C illustrate an example fan beam in an underwater environment in accordance with one or more embodiments of the present disclosure. A transducer 420 generates and emits a fan beam 430. The transducer 420 may be oriented with a target plane of floor 404. The illustrated edges of the fan beam 430 in FIGS. 4A-4C are determined by the −3 dB down points of the main lobe of the fan beam 430.

In various embodiments, the motion and/or velocity of the transducer 420, as well as an associated vehicle, may be measured along a measurements axis 452 associated with the wide dimension of the fan beam 430.

FIG. 4A illustrates a cross-section of a wide dimension of fan beam in an underwater environment in accordance with one or more embodiments of the present disclosure. FIG. 4B illustrates a cross-section of a narrow dimension of fan beam in an underwater environment in accordance with one or more embodiments of the present disclosure.

The fan beam 430 generated and emitted from the transducer 420 may be associated with a maximum range 442 along a measurement axis 452. The maximum ranges 442 and measurement axis 452 may be associated with the wide dimension of the fan beam 430 as it is emitted onto a target plane 404 (e.g., floor 104). The transducer 420 is a distance away from the target plane of the floor 404, which may be referred to as a standoff 462 or a standoff distance. As projected, the fan beam 430 is emitted within a first edge and a second edge of the fan beam 430 in the wide dimension. The first edge may be a lower edge 434A of the fan beam 430 and the second edge may be an upper edge 434B of the fan beam 430. Between this first edge and second edge is where the beam is emitted onto the floor 404. In some embodiments, this may be referred to as targeting or painting the floor 404 with the beam.

FIG. 4C illustrates a cross-section of a wide dimension of fan beam in an underwater environment in accordance with one or more embodiments of the present disclosure. FIG. 4C further illustrates a main axis of the fan beam that has a slant range 466. The slant range 466 is, with a flat floor 404, middle distance between the first edge 434A and the second edge 434B. The slant range 464 may be at an angle and be comprised of a first distance in an X-direction extending along the measurement axis 452 and a second distance extending along the standoff 462. The first distance may be an along-track range 464 and the second distance may be a standoff distance 462. The geometry of two of these distances or measurements may be used to determine the third, such as described herein.

In various embodiments the transducer 420 may be oriented in one or more orientations. In some orientations the transducer 420, and thus the fan beam 430, may be oriented to maximize a distance covered by the fan beam 430 based on one or more parameters for operating the transducer. Such parameters may include, for example, maximum allowable time of flight, power, transducer sensitivity, target plane reflectivity, medium of the environment, and/or other application-specific constraints.

For example, a transducer pointed directly at the target plane (e.g., directly down). Then the transducer may be rotated (e.g., rotate up) until it reaches an angle associated with a maximum range. In such an orientation the transducer 420 is configured to emit a fan beam 430 over the maximum range 442.

The maximum range is associated with a maximum slant range 466 where a return signal may be detected. In various embodiments, a slant range 466 may be a direct distance between a transducer 420 and a point of interest. This may, or may not, be a point where an object (e.g., 106), phenomenon, or the like reflects a signal.

Various embodiments may orient the transducer at an angle beyond the maximum slant range 466 to address certain environments. For example, if an environment were to include any forces (e.g., currents, winds, movement, etc.) that may cause the transducer to pitch and/or roll, then the orientation angle may be configured to account for such movement by orienting the transducer at an angle beyond the maximum slant range 466.

The minimum standoff 462 of a transducer 420 from a floor 404 may vary, including by operating frequency, contours of the floor 404, etc.

As the transducer 420 approaches a floor 404 it will, for a given angle of orientation, be able to illuminate or radiate less and less of the measurement axis 452 of the target plane of the floor 404, particularly if variations in the floor 404 occlude the fan beam 430. In various embodiments, the standoff 462 may be no more than one-half a maximum range 442.

Additionally or alternatively, in various embodiments the transducer standoff 462 is not more than the distance where the length of the lower edge 434A of the fan beam 430 intersects the target plane (e.g., 404) at maximum measurement range 442. At such a standoff 462, a velocity estimation for the fan beam 430 may be minimally accurate and an accuracy estimation may improve as the standoff 462 decreases until the accuracy estimation starts to decrease again, such as with angle of orientation greater than beyond the maximum slant range 466.

For example, various embodiments may including determining a standoff distance 462. There may be a distance or depth sensor to determine a standoff distance 462. For example, for a narrow beam depth sounder there is measurement axis that provides a distance or depth from the floor. In various embodiments there may also be pitch and roll of a transducer 120 and the system may adjust the standoff distance to account for the pitch and/or roll. Such pitch and/or roll may be determined by other sensors. In various embodiments, standoff distance may be different for each ping or cycle and thus the determination of standoff distance may be associated with a specific time period and/or measurement cycle for receiving reflections.

It will be appreciated in in operation a transducer 420 emits a pulse for specific length of time or pulse length. This pulse is the fan beam 430 for a first period of time that is the pulse length. The transducer 420 then ceases emitting a fan beam 430 for a period of time and waits to receive reflections. This may be referred to as illuminating an area with the fan beam 430 and waiting for reflections or returns. In various embodiments, a transducer 120 may include a transmit transducer and a receive transducer. The transmit transducer may be located with (i.e., co-located) with the receive transducer, such as in a transducer housing. Alternatively, in various embodiments the transmit transducer may be located separately from the receive transducer. If separate receive and transmit transducers are used, the beam patterns may not be identical, although embodiments may include transmit beam patterns that may cover the entire receive beam pattern. In various embodiments utilizing a transmit transducer and a separate receive transducer, use of the phrase transducer may generally refer to both of the transmit transducer and the receive transducer collectively, particularly when performing one or more operations described herein.

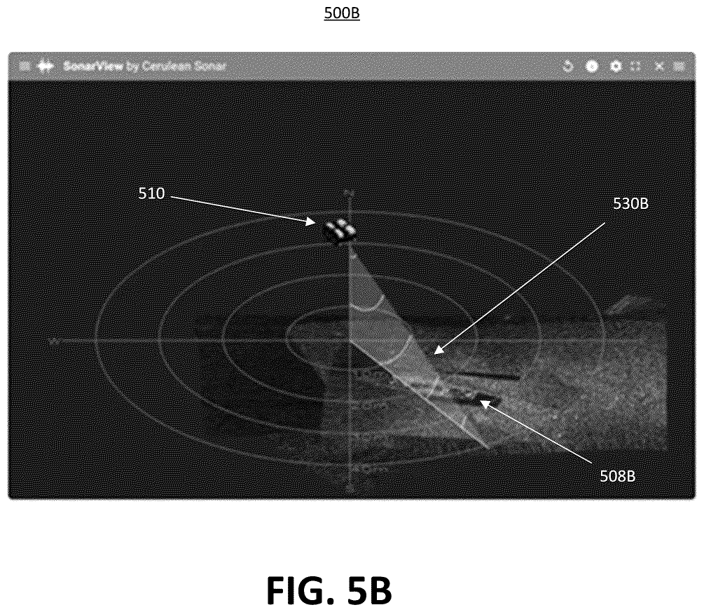

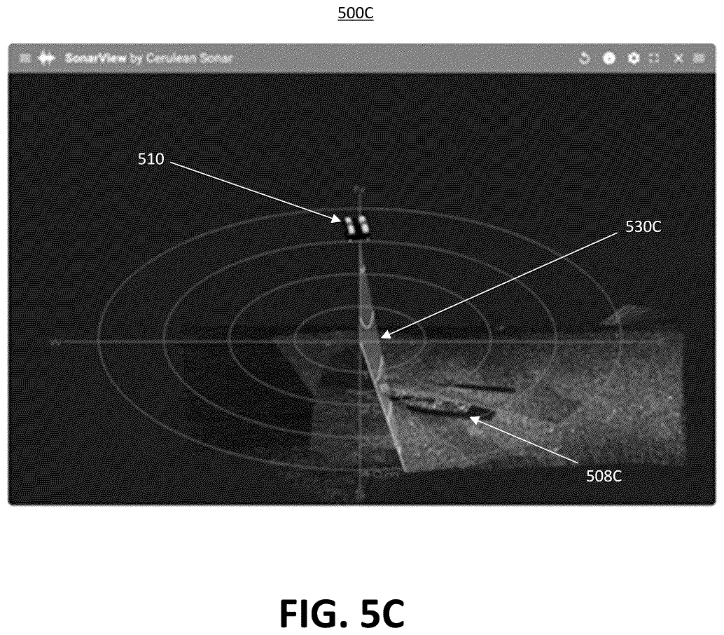

FIGS. 5A-5C illustrate exemplary images of an underwater vehicle with a transducer using a fan beam sonar in accordance with one or more embodiments of the present disclosure. The figures depict how an underwater environment may be imaged. This may allow for an underwater vehicle to image an underwater environment, such as by moving and/or rotating to generate an image from return signals associated with fan beams. The imaging may be of one or more objects of interest (e.g., 540). In various embodiments, a vehicle may, after identifying an object of interest and/or based on a user's inputs, be controlled to move towards (or away) from an object. The vehicle may also determine a distance and/or velocity in a direction, such as described herein, which may be used to move or control the movement of the vehicle. As the vehicle 110 moves, subsequent fan beams 130 emitted allow for updated images that allow for displaying progress on a display of the movement of the vehicle 110 as it progresses toward a target.

FIGS. 5A-5C are examples of displays (e.g., screenshots) that render an image of an underwater environment. This may include depicting an underwater vehicle 510 emitting a fan beam 530 to map the floor, including floor surfaces and objects. In various embodiments, the fan beam 530 may also be used to determine or estimate a velocity of the underwater vehicle 510. This velocity may, among other things, be used to compensate for motion of the underwater vehicle 510. The compensation for a vehicle's motion, such as the underwater vehicle 510, may be used to update a display presented to a user.

The velocity of the underwater vehicle 110, once determine, may be used for the rendering of the image to include moving the seabed in relation to the underwater vehicle to compensate for vehicle motion. This improves displaying the underwater environment rendered in the display, including making the displayed return signals easier for a user to understand, particularly as a vehicle may move. For example, a transducer 120 may be mounted to an underwater vehicle or a surface vessel and movement (e.g., drift) may be accounted for in the image displayed to a user. Thus the image displayed may paint an image of the scanned area of the sea floor to provide improved situational awareness. This may provide improved imaging, including in areas of low visibility. For example, while a surface vessel or a boat may drift or move, utilizing a transducer 120 generating fan beams 130 in accordance with the present disclosure may allow for a user to have visibility into murky water with low visibility even while the boat moves due to compensation of the image data being displayed.

To compensate for the velocity of the vehicle 110, image data for rendering on a display may be compensated based on the velocity and returns received of the reflections of the fan sonar beam 530. The reflections may be used to generate return signals, which are referred to as returns. These return signals or returns may be used to generate initial image data. One or more velocities are also determined. The initial image data may be compensated or updated based on the one or more velocities. For example, a display may render image data, including one or more positions of a floor 104 as well as floor contours 106 and/or objects 108. The image rendered may, or may not, also include an image or reference of the vehicle 110, such as with underwater vehicle 510. Image data may be updated to compensate for the movement of the underwater vehicle 510 based on one or more velocities determined from the return signals. In various embodiments, compensation for movement may include adjusting image data previously rendered on the display to update the display for velocity of the underwater vehicle 110. As illustrated in FIGS. 5A-5C, the images may be geometrically correct images. These images may be rendered live in real time. Alternatively and/or additionally, these images may be stored or recorded for later rendering during a playback.

FIG. 5A depicts the underwater vehicle 510 projecting a fan beam 530 on to a floor 104 of a seabed. The fan beam 530 is emitted over a range in a wide dimension that extends from a transducer mounted to the underwater vehicle 510. The fan beam 530 is projected onto the floor 104 of the seabed, including contours and objects (e.g., 508) on or in the seabed. Reflections of the fan beam are transmitted back to transducer mounted on the underwater vehicle 510. The transducer receives the reflections and converts them to an electrical signal, which may be referred to as return signals or returns. The return signals are sampled at a sampling rate. The samples are used to generate image data that is displayed on a display a user may see. The returns are thus used to generate image data that is rendered on a display for a user to see. The image displayed may be of, as depicted, an underwater environment.

FIGS. 5B and 5C illustrate additional images such as depicted in FIG. 5A with the image updated as additional returns are received and the underwater vehicle 510 moves. In various embodiments, such as in FIGS. 5A-5C, a display is updated as the returns are received. For example, as an underwater vehicle 510 moves and/rotates, additional returns will be received and a display is updated with new images to render.

For example, FIG. 5A depicts the underwater vehicle 510 at a first time and in a first position and depicts a display of returns associated with fan beam 530A. Among other things, the returns displayed include reflections from an object at a first position of 508A.

FIG. 5B depicts the underwater vehicle 510 at a second time and in a second position. The second time is later than the first time. At this second time, the underwater vehicle 510 has moved and/or rotated. Thus the fan beam 530B has over a first time interval between the first time and the second time continued to generate reflections from, among other things, the object, which is now the object at a second position of 508B. As is readily appreciated, the display has been updated to display, among other things, the object at the second position 508B that is different from the object at the first position 508A. This includes the display with the fan beam 530B being displayed in a different angle with respect to the underwater vehicle 510 to reflect the movement and/or rotation of the underwater vehicle 510 over this first time interval.

FIG. 5C depicts the underwater vehicle 510 at a third time and in a third position. The third time is later than the second time. At this third time, the underwater vehicle 510 has further moved and/or rotated. Thus the fan beam 530C has over a second time interval between the second time and the third time continued to generate reflections from, among other things, the object, which is now the object at a third position of 508C. As is readily appreciated, the display has been updated to display, among other things, the object at the third position 508C that is different from the object at the first position 508A and the object at the second position 508B. This includes the display with the fan beam 530C being displayed in a different angle with respect to the underwater vehicle 510 to reflect the movement and/or rotation of the underwater vehicle 510 over this second time interval.

In various embodiments, the images of FIGS. 5A-5C may each be a mosaic of smaller images that are compiled together. As the position of the underwater vehicle 510 moves, the mosaic may be updated to compensate for the movement of the underwater vehicle 510 based on the velocity.

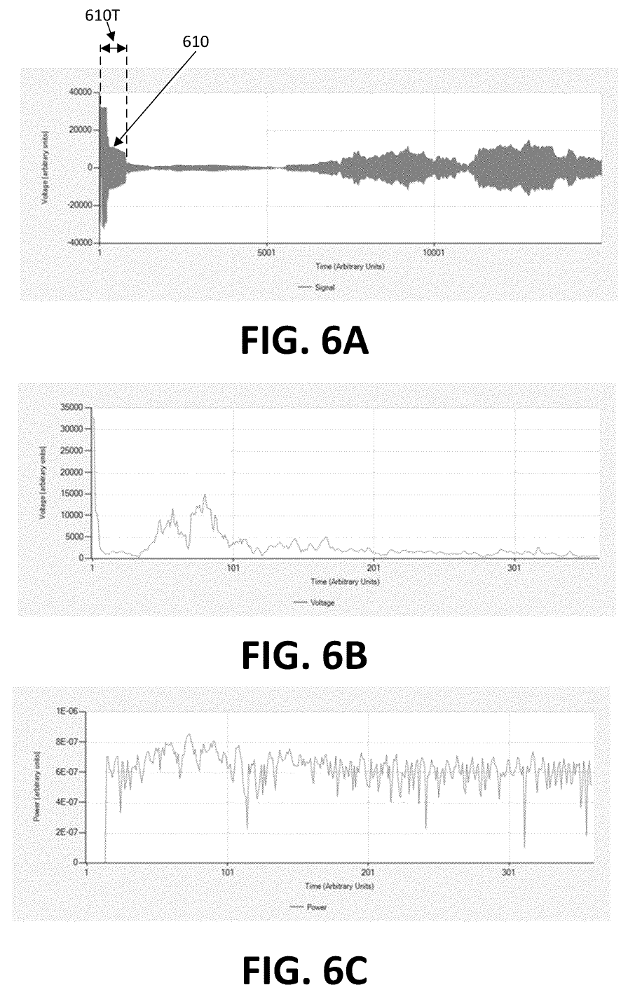

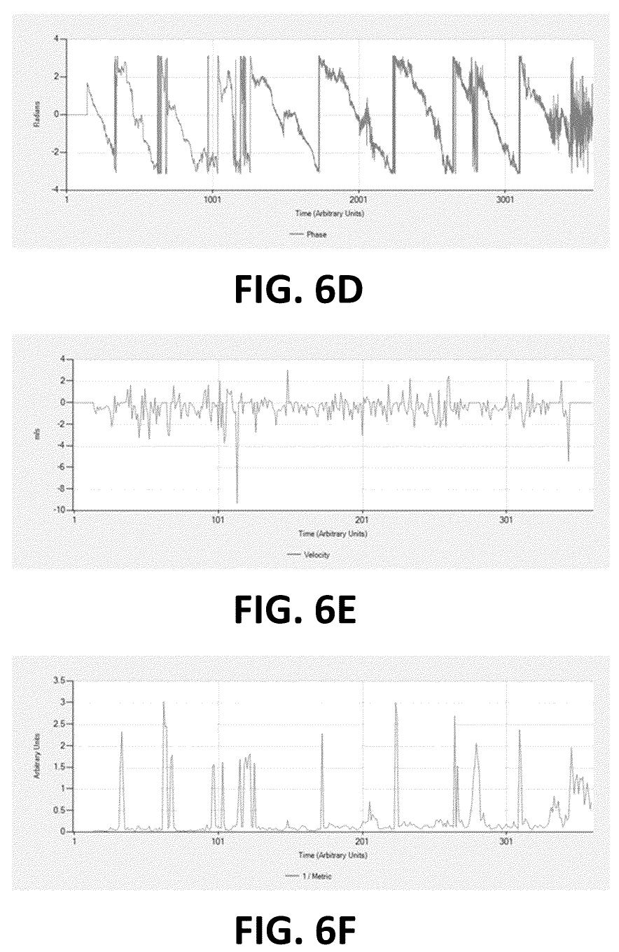

FIGS. 6A-6F illustrate graphs of return signal processing operations in accordance with one or more embodiments of the present disclosure.

The reflections received from a fan sonar beam 130 transmitted from a transducer 120 may be used by a sonar system to determine a Doppler shift and generate images, including compensating for velocity. A sonar system of an underwater vehicle 110 may generate and cause a broadcast signal to be transmitted to the transducer 120 to cause the transducer to generate the fan beam 130 at a broadcast frequency based on the broadcast signal. The fan beam 130 transmitted may be referred to as a ping. The transmission or ping of the fan beam 130 based on the broadcast signal may be or may include a one or more cycles (e.g., time on and time off) for generating a plurality of fan beams 130 over transmission time period. In various embodiments this may be referred to as a ping cycle or a measurement ping cycle. When the fan beam 130 reaches the floor 104, including contours 106 and/or objects 108, one or more reflections are generated and travel towards the transducer 120. The transducer 120 receives the one or more reflections. On receiving the one or more reflections, the transducer 120 may generate one or more return signals that may be sampled. For example, the vehicle 120 may digitally sample a return signal at a first sampling frequency (e.g., 2.7 MHz). The sampling frequency may generate samples with a sample time (tₛ). This sample time may be associated with a slant range distance.

FIG. 6A illustrates a time series of a 15,000 samples of a measurement cycle in accordance with one or more embodiments of the present disclosure. These may be a first 15,000 samples of a measurement ping cycle. In various embodiments, the total measurement for this measurement ping cycle may be 60, 150 samples, which may correspond to a maximum slant range of approximately 25 meters. In FIG. 6A, the transmission of the fan beam 130 (e.g., the ping 610) may be seen on the left side and is approximately the first 1800 samples, which may correspond to a ping time 610T of 1 mS, which is associated with a ping length of 1.484 meters.

FIG. 6B illustrates a power graph of a positive half of a received signal envelope of a complete measurement cycles that is divided into sample bins. In various embodiments, a sample bin is an arbitrary unit of time that the sonar system may set when processing return signals. For example, these sample bins may be the positive half of the signal amplitude envelope for 60,150 samples associated with the 15,000 samples illustrated in FIG. 6A. In various embodiments, as the amplitude of the return signals may be the same positive amplitude and negative amplitude (e.g., no offset or bias in the reflection), only a positive or only a negative portion (e.g., half) of the return signal may be sampled.

In various embodiments, the transmission of the fan beam 130 may include transmitting a large ping (e.g., a ping with a large amplitude) that may saturate a receiving chain of the sonar system. The receiving chain may be circuitry, hardware, and/or portions of the sonar system associated with receiving and/or processing a reflection and/or return signal. In various embodiments, the sonar system may delete, disregard, or ignore the portion of the samples associated with the transmission of the fan beam 130. For example, the sonar system may not listen or record reflections received for a time period associated with transmitting the fan beam 130. Alternatively and/or additionally, the sonar system may use a filter or threshold to determine when a return signal is saturating the receiving chain. In various embodiments, this threshold may be adjusted based on if the sonar system if transmitting or not. As shown in FIG. 6B, the first few sample bins exceed 15000 units of voltage, which is much greater than the remainder of the sample bins illustrated in FIG. 6C. In various embodiments, one or more of these samples may be deleted, disregarded, or ignored in further processing. In various embodiments, additionally samples associated with these early sample bins may also be deleted, disregarded, or ignored.

FIG. 6C illustrates power graph of sample bins for a complete measurement cycle. The vertical scale of FIG. 6C is a logarithmic scale of the power of the samples, which are plotted at log 10. In FIG. 6C, the samples for the portion of the return signals saturated by the transmission of the fan beam 130 have been deleted, disregarded, or omitted.

In various embodiments, the sample bins of the voltage graph of FIG. 6B correspond with the sample bins of FIG. 6C. This correspondence is because the phase of the return signal(s) is not coherent, which may be due to the fan beam 130 reflecting off the floor 104, including one or more contours 106 and/or objects 108 at different ranges. Thus the reflections from the floor will be received at the transducer 120 at different times. These different times may be used to determine a velocity.

To determine a velocity the return signal generated by the transducer 120 from the reflections may be multiplied by the broadcast frequency to generate sine and cosine waves at the baseband signal frequency at that location in the received signal. These sine and cosine waves may be used to determine a Doppler shift. With the sine and cosine waves, the phase of the baseband signal can be determined at one or more points, which may allow for determining a Doppler frequency. The Doppler shift is associated with motion along the slant range axis 466.

A Doppler shift of a received return signal may be determined from a difference between a received frequency and the broadcast frequency. A baseband signal may be generated by performing down conversion on (i.e., down converting) the return signal. If the baseband signal has frequency of 0 Hz, then the Doppler shift is zero and there is no relative motion along the slant range axis. If the baseband signal has a negative frequency, the Doppler shift is negative indicating the relative velocity has a negative component along the measurement axis (e.g., transducer moved away from the target generating the reflection). If the baseband signal has a positive frequency, the Doppler shift is positive indicating the relative velocity has a positive component along the measurement axis (e.g., transducer moved towards from the target generating the reflection).

FIG. 6D illustrates a phase graph of intervals of the baseband phase in accordance with one or more embodiments of the present disclosure. In FIG. 6D, the phase points may be grouped. The groupings are illustrated in the graph by, for example, diagonal “slashes” in the graph. These are artifacts of a −315 Hz baseband signal. A single cycle at any frequency may change phase by 2π radians. These “slashes” in the graph of FIG. 6D represent or are associated with cycles of the baseband frequency. A single cycle at −315 Hz would include 356 samples of the graph of FIG. 6D. As may be observed by inspection of FIG. 6D, it will be appreciated that the duration of the “slashes” are at or approximately at −315 Hz. In an exemplary embodiment associated with FIG. 6D, the baseband phase has a Doppler shift of −315 Hz. FIG. 6D also illustrates approximately 10.5 cycles of −315 Hz.

Successive phase measurements may be grouped into sets. A single set may be referred to as a “bin.” Various embodiments may have different sizes of bins. In various embodiments, each bin may be 10 phase measurements, which is measured in time as associated with phase measurement time intervals. In FIG. 6B, phase measurements were made at intervals of (tₛ×16). The size of a bin associated with such intervals may then be 160 samples or (tₛ×160). In various embodiments, bins may be, maybe be less, or may be more than one-quarter ping in length.

For each bin, a bin frequency may be determined based on the phase measurements of the bin. For example, by determining a line through the phase measurements in the bin. In various embodiments this line may be based on a linear equation and/or best-fit line. The slope of this line may be converted to radians per second. Radians per second divided by 2π radians per cycle results in a frequency of cycles per second, which is the bin frequency.

A velocity v may be determined based, among other things, the Doppler frequency f_{d} of the baseband (a.k.a., the baseband Doppler frequency) and the carrier frequency fₛ of the ping (a.k.a., carrier ping frequency). In various embodiments using sonar transducers, the Doppler velocity may be further based on the speed of sound sₛ in water. In such embodiments, the velocity may be determined with the following formula:

$$v = ( {s}_{s} \times {f}_{d} ) / ( 2 {f}_{s} )$$

In various embodiments that are not underwater, the above equation will be adjusted for the respective environment and medium through which the fan beam is being transmitted (e.g., air, speed of light, etc.).

Certain bins may be rejected from further processing. For example, a phase coherence metric for a bin may be determined based on a standard deviation of the one or more phase measurements in the bin compared to an ideal phase line implied by a velocity v. Bins with a phase coherence metric greater than a threshold value may be rejected. This threshold may be set by a user or may be calibrated into a system. The threshold may be based on or associated with one or more parameters, such as the size of the bins, noise, and/or accuracy. In various embodiments, a phase coherence metric threshold of 0.4 may be used.

FIG. 6E illustrates a graph of velocity measurements in accordance with one or more embodiments of the present disclosure. The graph of FIG. 6E graphs velocity on the y-axis versus time on the x-axis. The velocity is based on phase measurements of FIG. 6D grouped into 10 bins. As illustrated, the velocity may change over time, including comparatively smaller change and some larger impulse changes. In various embodiments, such changes may be associated with how an underwater vehicle 110 may move over time with respect to a target object 108.

FIG. 6F illustrates a graph of phase coherence metrics in accordance with one or more embodiments of the present disclosure. The graph of FIG. 6F graphs phase coherence metric on the y-axis versus time on the x-axis. The phase coherence metrics are determined as described herein and are associated with the velocities graphed in FIG. 6E.

For each bin, the standoff range 462, along-track range 464, slant range 466, and velocity may be determined. The velocity for each bin may be the velocity along the slant range 466, which may be referred to as the slant range velocity V_{SR}.

In various embodiments determining one or more of the standoff range 462 (R_{SO}), the along-track range 464 (R_{AT}), and the slant range 466 (R_{SR}) for each bin may be determined with trigonometry or the Pythagorean Theorem. For example, in various embodiments the standoff range 462 may be determined with a measurement from a sensor, such as with a side lobe of the fan beam, a second transducer, another sensor, etc. The slant range 466 may be determined based on one or more times associated with generating a ping and receiving a reflection. The slant range 466 may also be based on the medium the ping and reflection are traveling through, such as for example fresh water or salt water. The along-track range 464 may be determined based on the standoff range 462 and the slant range 466 with trigonometry or the Pythagorean Theorem.

A velocity may have multiple components with each component having its own direction (e.g., X-Y-Z coordinates). The components of the velocity along the slant range 466 may be the slant range velocity V_{SR}. The slant range velocity V_{SR} may be determined by resolving the determined velocity into component velocities of a standoff velocity V_{SO} and an along-track velocity V_{AT}. Such determinations may be by performing one or more of multiple operations.

In a first operation for determining the along-track velocity V_{AT}, the standoff velocity V_{SO} may be assumed to be zero. For example, and underwater vehicle may be considered to be holding a constant standoff range 462. The along-track velocity V_{AT} may be determined according to the following equation:

$${V}_{AT} = {V}_{SR} \times {R}_{AT} / {R}_{SR}$$

In a second operation for determining along-track velocity V_{AT}, if the standoff velocity V_{SO} is known, then this vertical velocity of the standoff velocity V_{SO} may be removed from the slant range velocity V_{SR} before determining the along-track velocity V_{AT} according to the following equation:

$${V}_{AT} = ( {V}_{SR} - {V}_{SO} / ( {R}_{SO} / {R}_{SR} ) ) \times {R}_{AT} / {R}_{SR}$$

In a third operation, and if multiple measurement axes are used, these measurement axes may be combined and each of the components may be determined. In various embodiments, bins with a slant range R_{SR} less than standoff range R_{SO} may be ignored. In various embodiments, a simplification may set an along-track velocity V_{AT} equal to the slant range velocity V_{SR}. For example, various embodiments may do this with bins where the slant range 466 is greater than a factor or multiple of the standoff range 462. This may be according to the following equation using k as a factor or multiple:

R_{SR}>k×R_{SO}

In various embodiments, k may be a factor or multiple that may be set based on an allowed error in the along-track velocity V_{AT} associated with the geometry a vehicle may be experiencing with an environment. In various embodiments, this multiple may be set by a user or may be dynamically determined and/or adjusted by a system based on measurements or geometries that are being made.

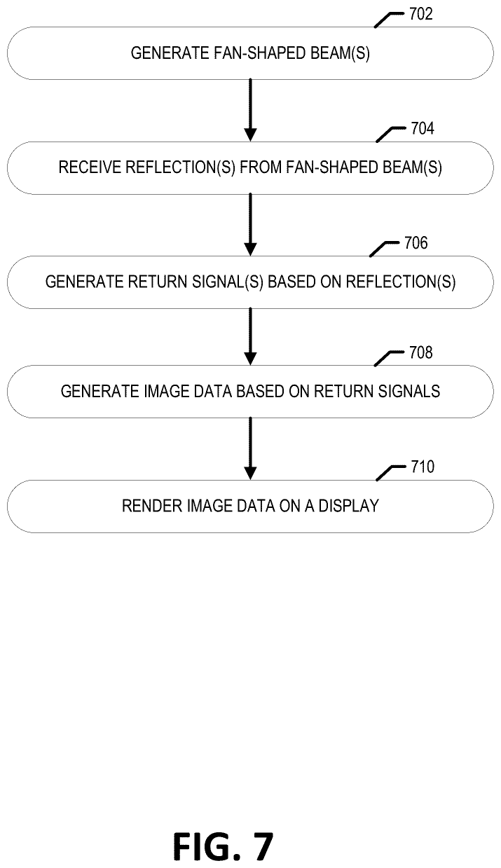

FIG. 7 illustrates an exemplary flowchart of operations for generating an image based on one or more fan sonar beams in accordance with one or more embodiments of the present disclosure.

At operation 702, generate fan beam(s). One or more fan beams may be generated as described herein. Each fan beam may a separate ping that is transmitted into an environments (e.g., underwater environment 100). The fan beam of a ping is generated based on one or more beam signals received by a transducer. In various embodiments with a single transducer element a single beam signal may be used to excite the single element. In various embodiments where a transducer may be comprised of an array of transducer elements there may be one or more beam signals that excite the array of transducer elements to collectively generate a fan beam. In various embodiments, a plurality of pings may be emitted during an ON portion of a transmit cycle followed by an OFF portion of the transmit cycle. The plurality of pings may be associated with a plurality of beam signals. Each of these beam signals may be at a respective time and is associated with a respective ping frequency, which may or may not be the same between pings.

In various embodiments, a processor may be configured to generate the beam signals that generate the pings. For example, a beam signal may be a short burst of a signal at a single frequency that may excite a transducer element to generate a fan beam at a broadcast frequency. The length of the ping may be associated with a signal speed or signal length. In various embodiments, a ping may have a length that is less than half an expected minimum standoff. In various embodiments, the expected standoff may be determined by the system based on previously measurements described herein, which may adjust the length of the ping by adjusting the length of the beam signal. Alternatively or additionally, a user may adjust or set thresholds for the beam signal.

At operation 704, receive reflection(s) from fan beam(s). The fan beams are emitted from the transducer and reflect off the floor, such as contours or objects in or on the floor. The reflections may be based on the reflectivity of the floor or objects. The reflections are transmitting in multiple directions, including back to the transducer.

At operation 706, generate return signal(s) based on reflection(s). When received by the transducer, the reflections are converted into electrical signals to generate return signals. The return signals from a single ping may be received over a time period as the different portions of the floor, contours, and/or objects associated with reflections may be located at different distances.

At operation 708, generate image data based on the return signals. The return signals may be used to generate image data to display the return signals on a display. The return signals may be processed, including as described further herein, to generate image data to be displayed. In various embodiments, the strength of the return signal may be displayed with different colors on a display to illustrate the different portions of the floor, contours, and/or objects that reflected the fan beam(s).

In various embodiments, the image data may be generated in a head unit that includes a display. Alternatively or additionally, the image data may be generated in a standalone sensor unit that that includes a processor so that the image data may be displayed on a display remote from the sensor unit.

In various embodiments, the return signals and/or image data may be stored for viewing later. This may include downloading the return signals and/or image data to another device (e.g., USB device) and/or transmitting the return signals and/or image data to another device (e.g., user device).

In various embodiments, the image data may include data for one or more images. Generating the image data may include generating these images. Multiple images may be collectively included in image data so that the image data may be sent, transmitted, or streamed to a display or device with a display. In various embodiments, generating images and/or image data based not only on the reflections but also on measurements of data associated with the reflections, such as but not limited to velocity. For example, image data may be generated and then this image data may be compensated for velocity, which is described herein.

At operation 710, render image data on a display. The display may be part of the system including the transducer or the display may be remote from this system. For example, an underwater vehicle 110 may not include a display and may, instead, transmit the image data to a remote display. Such a remote display may be on a surface vessel or on a user device associated with a user on the surface vessel. These remote displays may receive the image data and render the image data on the display. Rendering the image data may include, for example, addressing display specific parameters, such as display size, display colors, display refresh rates, and the like. In rendering the image data the display parameters may be used to adjust the images rendered from the display data.

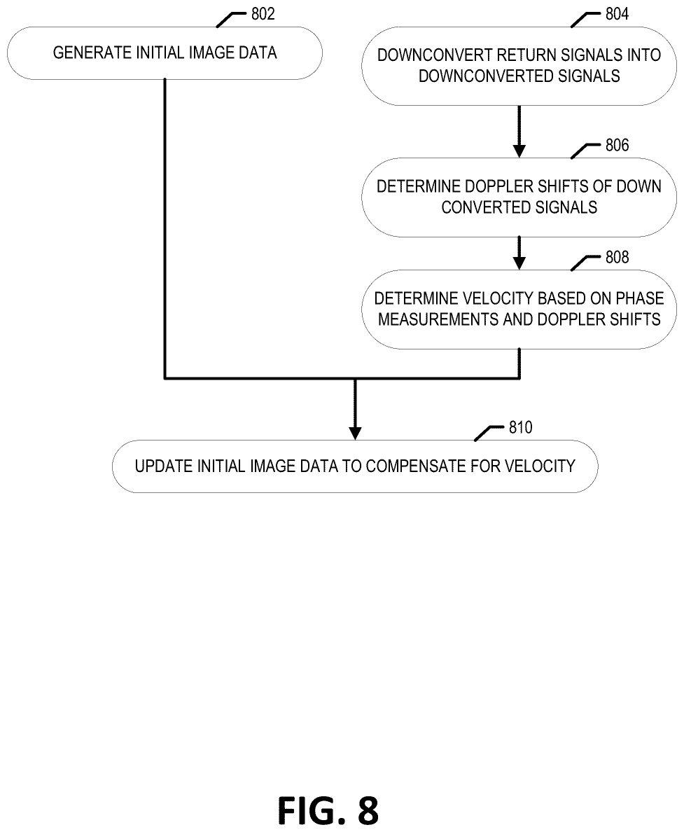

FIG. 8 illustrates an exemplary flowchart of operations for generating image data based on velocity and reflections in accordance with one or more embodiments of the present disclosure. In various embodiments, the image data may include image data for one or more images that have been compensated for velocity. This may include initial image data based on reflections that is updated based on velocity to generate image data that has been compensated for velocity.

At operation 802, generate initial image data based on reflections. The initial image data may be based on return signals received from one or more reflections. The return signals may be composted together to generate one or more images in the image data. In various embodiments, these initial images may be updated over time to incorporate new image data associated with recent return signals and/or reflections over time while dropping off image data associated with older return signals and/or reflections.

In various embodiments, operation 802 may be performed in parallel with operations 804-810. Alternatively and/or additionally, in various embodiments these operations may be performed in a different order, such as serially.

At operation 804, generate down converted signals based on return signals. Each return signal has an associated broadcast frequency, which may also be referred to as a carrier frequency. The broadcast frequency is the frequency at which the fan beam leading to a reflection was broadcast. The reflection associated with the fan beam also has this broadcast frequency, which may or may not be shifted. The return signals may be down converted from the broadcast frequency to a baseband frequency. Down converting may also be referred to as heterodyning.

In various embodiments, down converting may be performed by multiplying a return signal with a first frequency of f1 by a reference signal with a second frequency of f2. This results in new frequencies of f3 and f4. This multiplications generates two additional signals of a third signal with a third frequency at f3=f1−f2 and of a fourth signal with a fourth frequency f4=f1+f2. Using a low-pass filter, the lowest frequency of these four signals of f3 may be kept while rejecting the signals at f1, f2, and f4. In various embodiments, if f1 and f2 are close in frequency, the residual signal f3 be near DC. This third signal that is kept and not rejected by the low-pass filter is the down converted signal(s), which may be referred to as a baseband signal(s) having a baseband frequency of f3.

In various embodiments, generating down converted signals may include storing a plurality of returns signals over a period of time and sampling the stored return signals, including creating one or more bins as described herein.

At operation 806, determine a Doppler shift in the down converted signals. The Doppler shift in the down converted signal may be based on the baseband frequency f3. A Doppler shift may be a difference between a frequency of the down converted signals and the broadcast frequency. The Doppler shift may be determined as described elsewhere herein.

In various embodiments, if the down converted signals have a baseband frequency of 0 Hz, then the Doppler shift is zero and there is no relative motion along the slant range axis of the reflections associated with the return signals used to generate the down converted signals. If the down converted signals have a baseband frequency with a negative frequency, the Doppler shift is negative indicating the relative velocity has a negative component along the measurement axis (e.g., transducer moved away from the target generating the reflection). If the down converted signals have a baseband frequency with a positive frequency, the Doppler shift is positive indicating the relative velocity has a positive component along the measurement axis (e.g., transducer moved away from the target generating the reflection).

Determining a Doppler shift may include determining a plurality of phase measurements associated with the Doppler shift. This is described further herein, including the use of bins and/or a best-fit line as well as rejecting bins if a phase coherence metric is above a threshold.

At operation 810, determine a velocity based on the phase measurements and the Doppler shifts. An initial velocity may be based on the baseband frequency, the broadcast frequency, and a constant associated with an environment (e.g., speed of sound in water) as described elsewhere herein. This initial velocity may be the velocity along the slant range 466. As also described herein, this initial velocity may be divided into one or more components of a velocity in the standoff range 462 and a velocity in the along-track range 464. In particular, the velocity in the along-track range 464 may be determined. Additionally, the velocity in the component directions for a time period that includes a plurality of bins may be aggregated to determine the velocity use to update the initial images.

At operation 812, update initial image data to compensate for velocity. In various embodiments, the initial image data may represent how the floor 104 may appear to a user when displayed, such as with FIGS. 5A-5C. The image data may be generated to, when rendered, display the floor contours (e.g., 106) and objects (108) in reference to the underwater vehicle 510 having the transducer 120. As the underwater vehicle moves in one or more directions, how any of the contours and/or objects appears in relation to each other and/or the underwater vehicle may be updated based on the velocity. This may allow for updating the image data to reflect rotating and/or shifting of the locations of the contours and/or objects so that a user looking at an image rendered on a display may easily recognize what is displayed. This is illustrated in FIGS. 5A-5C with an object of interest 540 (e.g., a wreck), which is assembled from image data associated with multiple return signals, being kept together, rotated, and moved in relation to the underwater vehicle 510. Thus the initial image data may be updated to compensated for velocity of the system with the transducer.

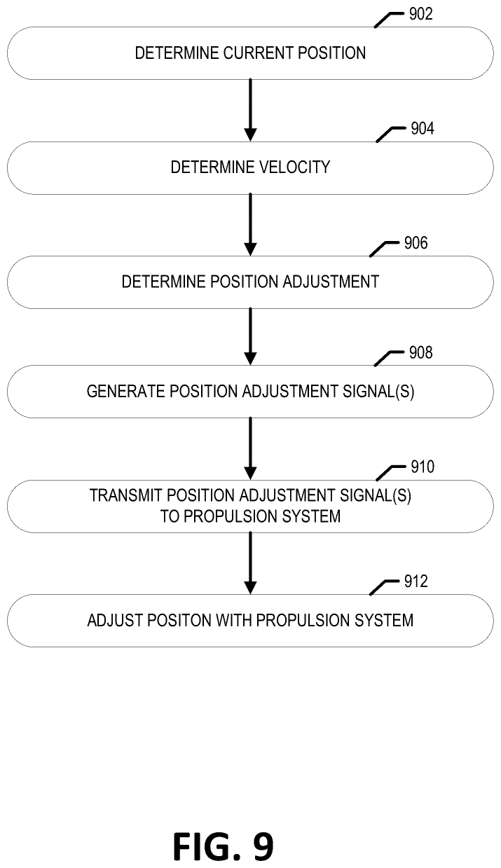

FIG. 9 illustrates an exemplary flowchart of operations for positioning a vehicle in accordance with one or more embodiments of the present disclosure.

At operation 902, determine current position. The current position may be determined based on one or more signals from another sensor, such as a GPS signal. Additionally and/or alternatively, the current position may be determined based on a past position adjusted for movement related to one or more velocities.

At operation 904, determine velocity. A velocity may be determined as described herein, such as based on one or more reflections from fan beams.

At operation 906, determine position adjustment. Determine a position adjustment based on the current position and a prior position. In various embodiments, the position adjustment may be based on holding a vehicle in a current position and the position adjustment may be do counteract one or more forces. These forces are associated with the velocities determined that cause the vehicle to move in relation to the one or more velocities.

In various embodiments, a position adjustment may not need to be exact but may have a threshold associated with acceptable positioning. A velocity threshold may be used and the determining of position adjustment may be based on if the velocity exceeds this velocity threshold. The velocity threshold may also be used in conjunction with a time period to determine if the velocity multiplied by time is associated with a change in position. If the velocity exceeds this velocity threshold, then it may be determined a position adjustment is needed and by how much.

If not position adjustment is needed, one or more operations may be iterated to continuously monitor for position adjustment.

At operation 908, generate position adjustment signals. When it is determined that a position adjustment is needed, one or more position adjustment signals may be generated. In various embodiments, the position adjustment signals may be configured to an associated propulsion to provide one or more signals to cause the propulsion system to operation to perform the adjustment. For example, underwater vehicle 110 have a propulsion system that includes one or more propellers, jets, rudders, fins, or the like. The one or more position adjustment signals may be signals to cause operation of the different portions of the propulsion system. Alternatively and/or additionally, the position adjustment signals may be a signal to a processor of the propulsion system to provide the propulsion system with the position adjustment and then the propulsion system may generate respective signals to operation the portions of the propulsion system.

At operation 910, transmit position adjustment signals to propulsion system. The adjustment signals may be transmitted to the propulsion system. In various embodiments, this may include transmitting adjustment signals to one or more portions of the propulsion system. Alternatively, this may include transmitting adjustment signals to the propulsion system, which then processes the signals to operate portions of the propulsion system.

At operation 912, adjust position with propulsion system. The propulsion system may operate based on the position adjustment signals to adjust the position of the vehicle. This may include controlling the vehicle move the vehicle in one or more directions and/or to hold the vehicle in position. This control may include counteracting one or more forces that may moving the vehicle of the environment and, thus, generating the one or more velocities determined. In various embodiments, the control may include controlling the position for any pitch and/or roll that the vehicle may be experiencing. In various embodiments, the control of movement and/or propulsion may be for a period of time. Then subsequent position adjustment signals may be received for further adjustments based on further velocity determinations.

In an exemplary embodiment, the velocity of a vehicle (e.g., an underwater vehicle 110) may be used by the vehicle to hold the vehicle in position or control movement of the vehicle. For example, an underwater vehicle 110 may have a propulsion system that may be controlled based on the velocity (ies) of the underwater vehicle 110. This may be to compensate or correct for one or more force in an environment (e.g., currents, drift, etc.). In various embodiments, such positioning may be used to track or image a target. In an exemplary embodiment, an underwater vehicle 110 may be determined to be moving or have moved based on the velocity (ies). One or more signals may be generated and transmitted to the propulsion system to be used to by the propulsion system to generate one or more forces that may move the vehicle 110. The propulsion system may be used to move the underwater vehicle 110 to counteract forces on the underwater vehicle 110, such as currents on an underwater ROV.

In various embodiments, positioning and/or holding of an underwater vehicle 110 may allow for control of position, including if or when one or more other positioning signals (e.g., GPS, etc.) are not present or not being used. For example, if a system of an underwater vehicle 110 may include one or more transducers 120 and a GPS system, if the GPS system failed or a signal error associated with the GPS occurred then the velocities may provide positioning information used to control movement of the underwater vehicle 110.

In various embodiments, the underwater vehicle 110 may focus on a target by “painting” the target with the fan beam and control the position of the underwater vehicle around the target. Examples of targets associated with an underwater vehicle may include pipelines, wrecks, refers, vegetation beds, and the like.

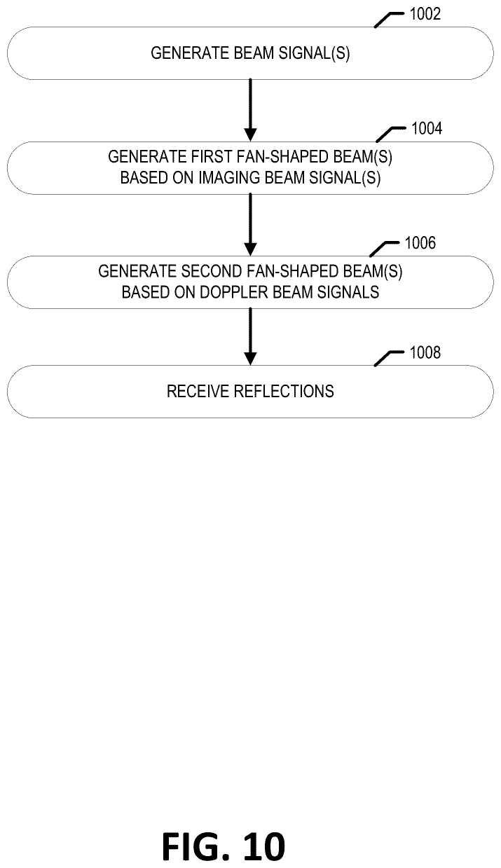

FIG. 10 illustrates an exemplary flowchart of operations for interleaving imaging fan beams and Doppler fan beams in accordance with one or more embodiments of the present disclosure. This may also be referred to interleaving imaging pings and Doppler pings. Various embodiments may include more than one type of fan beam 130, which may be at the same or different frequencies.

At operation 1002, generate beam signals. In various embodiments, a sonar system may generate beam signals, including a first signal at a first time and a second signal at a second time. The first signal may be an imaging beam signal. The second signal may be a Doppler beam signal. The imaging beam signal and the Doppler beam signal may have the same frequency or may have different frequencies, such as an imaging frequency and a Doppler frequency.

In various embodiments operation 1002 may occur at two different time periods. For example, during the second time period the transducer may be generating one or more fan beams associated with the first signal generated at a first time period.

At operation 1006, generate first fan beams based on imaging beam signals. The imaging beam signal is transmitted to a transducer. The imaging fan beam(s) is generated based on the imaging beam signals.

At operation 1010, generate second fan beams based on Doppler beam signals. Subsequent to the generation of the first fan beams, the Doppler beam signal is transmitted to the transducer. The second fan beam(s) is generated based on the Doppler beam signals.

At operation 1012, receive reflections. After generating the first fan beams and the second fan beams there may be a period when no beams are generated to allow for reflections to be received. Some of the reflections received will be at the imaging frequency and associated with the imaging fan beams. Some of the reflections will be at the Doppler frequency and associated with the Doppler fan beams.

The received reflections will be used to generate, respectively, imaging return signals and Doppler return signals. Each of these types of returns signals may respectively be used to generate imaging data and determine, among other things, velocity.

In various embodiments, the interleaving may be every other ping. Alternatively, the cadence of interleaving may be another cadence (e.g., two imaging pings to one Doppler ping, etc.). In various embodiments, the interleaving may be turned on or off based on an interleaving mode setting set by a user.

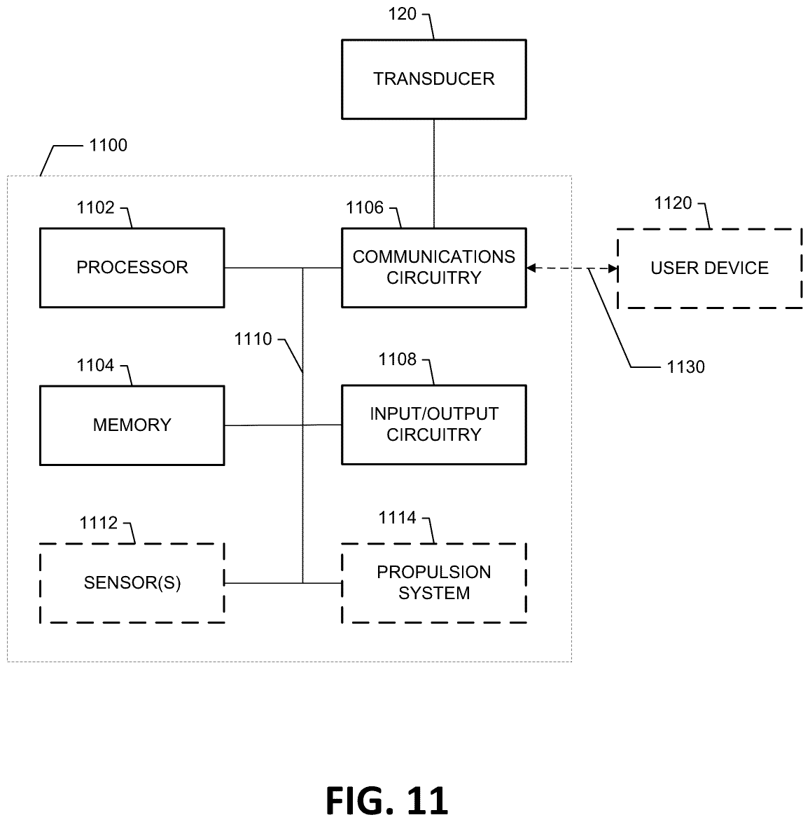

FIG. 11 illustrates an example block hardware diagram of a device in accordance with one or more embodiments of the present disclosure. Exemplary embodiments of the device 1100 may include, for example, sonar systems, radar system, laser systems, including vehicles with these systems. The device 1100 illustrated includes a processor 1102, memory 1104, communications circuitry 1106, input/output circuitry 1108, sensors 1112, and a propulsion system 1114, which may all be connected via a bus 1110, and a transducer 120. The device 1100 illustrated may be connected to a user device 1120, such as with a connection 1130. The connection 1130 may be a wired and/or wireless connection. In various embodiments, the transducer 120 may be external to a device 1100 (e.g., mounted externally to an underwater vehicle) and connected via the communications circuitry 1106. Alternatively or additionally, the transducer 120 may be connected via the input/output circuitry 1108. In various embodiments, the device 110 may omit one or more of the illustrated blocks, such as omitting sensors 1112 and/or propulsion system 1114.

The processor 1102, although illustrated as a single block, may be comprised of a plurality of components and/or processor circuitry. The processor 1102 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits, such as ASICs, FPGAs, systems-on-a-chip (SoC), or combinations thereof. In various embodiments, the processor 1102 may be configured to execute applications, instructions, and/or programs stored in the processor 1102, memory 1104, or otherwise accessible to the processor 1102. When executed by the processor 1102, these applications, instructions, and/or programs may enable the execution of one or a plurality of the operations and/or functions described herein. Regardless of whether it is configured by hardware, firmware/software methods, or a combination thereof, the processor 1102 may comprise entities capable of executing operations and/or functions according to the embodiments of the present disclosure when correspondingly configured.

The memory 1104 may comprise, for example, a volatile memory, a non-volatile memory, or a certain combination thereof. Although illustrated as a single block, the memory 1104 may comprise a plurality of memory components. In various embodiments, the memory 1104 may comprise, for example, a random access memory, a cache memory, a flash memory, a hard disk, a circuit configured to store information, or a combination thereof. The memory 1104 may be configured to write or store data, information, application programs, instructions, etc. so that the processor 1102 may execute various operations and/or functions according to the embodiments of the present disclosure. For example, in at least some embodiments, a memory 1104 may be configured to buffer or cache data for processing by the processor 1102. Additionally or alternatively, in at least some embodiments, the memory 1104 may be configured to store program instructions for execution by the processor 1102. The memory 1104 may store information in the form of static and/or dynamic information. When the operations and/or functions are executed, the stored information may be stored and/or used by the processor 1102.

The communication circuitry 1106 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 1104) and executed by a processor 1102. In various embodiments, the communication circuitry 1106 (as with other components discussed herein) may be at least partially implemented as part of the processor 1102 or otherwise controlled by the processor 1102. The communication circuitry 1106 may communicate with the processor 1102, for example, through a bus 1110. Such a bus 1110 may connect to the processor 1102, and it may also connect to one or more other components of the processor 1102. The communication circuitry 1106 may be comprised of, for example, transmitters, receivers, transceivers, network interface cards and/or supporting hardware and/or firmware/software, and may be used for establishing communication with another component(s), apparatus(es), and/or system(s). The communication circuitry 1106 may be configured to receive and/or transmit data that may be stored by, for example, the memory 1104 by using one or more protocols that can be used for communication between components, apparatuses, and/or systems. In various embodiments, the communication circuitry 1106 may communicate with a transducer 120 and/or a user device 1120. For example, the user device 1120 may be communicated with via a wireless or wired connection.

The input/output circuitry 1108 may communicate with the processor 1102 to receive instructions input by an operator and/or to provide audible, visual, mechanical, or other outputs to an operator. The input/output circuitry 1108 may comprise supporting devices, such as a keyboard, a mouse, a user interface, a display, a touch screen display, lights (e.g., warning lights), indicators, speakers, and/or other input/output mechanisms. The input/output circuitry 1108 may comprise one or more interfaces to which supporting devices may be connected. In various embodiments, aspects of the input/output circuitry 1108 may be implemented on a device used by the operator to communicate with the processor 1102. The input/output circuitry 1108 may communicate with the memory 1104, the communication circuitry 1106, and/or any other component, for example, through a bus 1110.

The sensor(s) 1112 may include one or more sensors for taking one or more measurements associated with the device 1100 and/or of an environment the vehicle is in. in various embodiments, the sensors 1112 may include depth sensors, GPS, temperatures sensors, pitch and roll sensors, etc. In various embodiments, the sensors may include one or more other transducers as well. In various embodiments, the sensors 1112 may be located in a housing, such as a sensor head, which may be located in or on a device 1100. Alternatively a sensor head may be mounted externally from the device 1100.

The propulsion system 1114 may provide for propelling the device 1100 (e.g., an underwater vehicle 110) in an environment. In various embodiments, the propulsion system may include propellers, jets, motors, wheels, tires, and the like that may be operated to propel or generate one or more forces to move or position a device 1100. In various embodiments, the system may generate one or more control signals that may be transmitted to a propulsions system. For example, the transducer and an associated processor may be externally mounted to a vehicle 110 and control signals may be transmitted to the vehicle 110 for use to control the propulsion system of a vehicle. For example, control signals may be transmitted over a wired connection (e.g., ethernet) or wirelessly.

The transducer 120 may be as described herein. Additionally, the transducer 120 may in a transducer housing that includes one or more other transducers, such as conical transducers, transmit transducers, and/or receive transducers. For example, in various embodiments, more than one transducer 120 may be mounted to a vehicle. For example, a first transducer 120A may be mounted to a vehicle 110 in a first direction and a second transducer 120B may be mounted to the vehicle 120 in a second direction. The second direction may be orthogonal to the first direction. With these two transducers the vehicle 110 may determine a velocity of the vehicle, such as described herein, in both the first direction and the second direction as described herein. In various embodiments the transducer may be mounted externally to the device 1100, such as with a fixed mount or a rotational amount, which may allow for the transducer to be rotated or aimed at a target.

A user device 1120 may be a personal device associated with a user (e.g., mobile device, mobile phone, laptop, head unit). Alternatively or additionally, the user device may be mounted remotely, such as at the helm of a surface vessel that may render image data on a display.

It should be readily appreciated that the embodiments of the systems and apparatuses, described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A sonar system comprising:
a transducer configured to generate a fan beam;
a display configured to render one or more images;
a processor and at least one non-transitory memory comprising computer program code, wherein the at least one non-transitory memory and the computer program code configured to, with the at least one processor, cause the sonar system to:
generate a plurality of fan beams with the transducer;
receive, with the transducer, a plurality of reflections based on the fan beams;
determine a velocity of the sonar system based on the reflections;
generate a plurality of first images based on the velocity and the reflections; and
render the plurality of first images on the display.

2. The sonar system of claim 1, wherein to generate the plurality of first images based on the velocity and the reflections the at least one non-transitory memory and the computer program code are further configured to, with the at least one processor, cause the sonar system to:
generate a plurality of initial images based on the reflections; and
generate the plurality of first images based on the plurality of initial images updated to compensate for the velocity of the sonar system.

3. The sonar system of claim 1, wherein to determine the velocity of the sonar system based on the reflections the at least one non-transitory memory and the computer program code are further configured to, with the at least one processor, cause the sonar system to:
generate a plurality of return signals based on the reflections, wherein the plurality of return signals have a frequency of a broadcast frequency;
generate a plurality of down converted signals by down converting the plurality of return signals from the broadcast frequency to a baseband frequency;
determine a Doppler shift in the plurality of down converted signals based on the baseband frequency;
determine the velocity of the sonar system based on a plurality of phase measurements of the plurality of down converted signals and the Doppler shift.

4. The sonar system of claim 1, wherein the display is located remotely from the transducer.

5. The sonar system of claim 4, wherein the transducer is mounted on an underwater vehicle.

6. The sonar system of claim 1 further comprising a conical transducer;
wherein the at least one non-transitory memory and the computer program code are further configured to, with the at least one processor, cause the sonar system to determine a depth of a standoff range with the conical transducer; and
wherein to determine the velocity of the sonar system is further based on the depth.

7. The sonar system of claim 1, wherein to render the plurality of first images on the display is to render the plurality of first images in real-time.

8. A method comprising:
providing a sonar system comprising:
a transducer configured to generate a fan beam;
a display configured to render one or more images;
generating, with the transducer, a plurality of fan beams with the transducer;
receiving, with the transducer, a plurality of reflections based on the fan beams;
determining a velocity of the sonar system based on the reflections;
generating a plurality of first images based on the velocity and the reflections; and
rendering the plurality of first images on the display.

9. The method of claim 8, wherein generating the plurality of first images based on the velocity and the reflections comprises:
generating a plurality of initial images based on the reflections; and
generating the plurality of first images based on the plurality of initial images updated to compensate for the velocity of the sonar system.

10. The method of claim 8, wherein determining the velocity of the sonar system based on the reflections comprises:
generating a plurality of return signals based on the reflections, wherein the plurality of return signals have a frequency of a broadcast frequency;
generating a plurality of down converted signals by down converting the plurality of return signals from the broadcast frequency to a baseband frequency;
determining a Doppler shift in the plurality of down converted signals based on the baseband frequency;
determining the velocity of the sonar system based on a plurality of phase measurements of the plurality of down converted signals and the Doppler shift.

11. The method of claim 8, wherein the display is located remotely from the transducer.

12. The method of claim 11, wherein the transducer is mounted on an underwater vehicle.

13. The method of claim 8, wherein the sonar system further comprises a conical transducer; wherein the method further comprises determine a depth of a standoff range with the conical transducer; and
wherein determining the velocity of the sonar system is further based on the depth.

14. The method of claim 8, wherein rendering the plurality of first images on the display comprises rendering the plurality of first images in real-time.

15. A system comprising:
a sonar system mounted to a vehicle, wherein the sonar system includes a transducer configured to generate a fan beam;
a display configured to render one or more images;
wherein the vehicle comprises a propulsion system configured to move the vehicle in a first environment;
a processor and at least one non-transitory memory comprising computer program code, wherein the at least one non-transitory memory and the computer program code configured to, with the at least one processor, cause the system to:
generate a plurality of fan beams with the transducer;
receive, with the transducer, a plurality of reflections based on the fan beams;
determine a velocity of the sonar system based on the reflections;
generate a plurality of first images based on the velocity and the reflections;
render the plurality of first images on the display; and
generate one or more position signals based on the velocity to cause the vehicle to move in one or more directions to hold the vehicle in a position and counteract one or more forces of the environment moving the vehicle.

16. The system of claim 15, wherein to generate the plurality of first images based on the velocity and the reflections the at least one non-transitory memory and the computer program code are further configured to, with the at least one processor, cause the sonar system to:
generate a plurality of initial images based on the reflections; and
generate the plurality of first images based on the plurality of initial images updated to compensate for the velocity of the sonar system.

17. The system of claim 15, wherein to determine the velocity of the sonar system based on the reflections the at least one non-transitory memory and the computer program code are further configured to, with the at least one processor, cause the sonar system to:
generate a plurality of return signals based on the reflections, wherein the plurality of return signals have a frequency of a broadcast frequency;
generate a plurality of down converted signals by down converting the plurality of return signals from the broadcast frequency to a baseband frequency;
determine a Doppler shift in the plurality of down converted signals based on the baseband frequency;
determine the velocity of the sonar system based on a plurality of phase measurements of the plurality of down converted signals and the Doppler shift.

18. The system of claim 15, wherein the display is located remotely from the transducer.

19. The system of claim 15, wherein the sonar system further comprises a conical transducer;
wherein the at least one non-transitory memory and the computer program code are further configured to, with the at least one processor, cause the sonar system to determine a depth of a standoff range with the conical transducer; and
wherein to determine the velocity of the sonar system is further based on the depth.

20. The system of claim 15, wherein to render the plurality of first images on the display is to render the plurality of first images in real-time.

21. (canceled)

22. (canceled)

23. (canceled)
